(19) United States
(12) Patent Application Publication
(10) Pub. No.: US 2015/0306576 A1
(43) Pub. Date: Oct. 29, 2015

(54) CATALYTIC METHOD FOR THE PRODUCTION OF CARBON MONOXIDE AND ASSOCIATED REACTOR

(71) Applicant: COMMISSARIAT A L'ENERGIE ATOMIQUE ET AUX ENERGIES ALTERNATIVES (CEA), PARIS (FR)

(72) Inventors: Jean-Marc Borgard, Orsay (FR); Phuangphet Vibhatavata, Versailles (FR); Michel Tabarant, Palaiseau (FR)

(21) Appl. No.: 14/412,812

(22) PCT Filed: Jul. 4, 2013
(86) PCT No.: PCT/FR2013/051586

§ 371 Date: Jun. 25, 2015

(30) Foreign Application Priority Data
Jul. 4, 2012 (FR) 1256434

(51) Int. Cl. B01J 23/89; C01B 3/02; B01J 37/02; B01J 37/04; B01J 37/03; B01J 37/08

(52) U.S. Cl. CPC B01J 23/894; B01J 23/8906; B01J 37/031; B01J 37/08; B01J 37/0201; B01J 37/04; C01B 3/02

(57) ABSTRACT

Process for the production of a synthesis gas, in which a gas mixture comprising carbon dioxide and hydrogen is brought into contact with a catalyst in order to produce carbon monoxide, the process being characterized in that the catalyst comprises iron and silver in a weight of silver/weight of iron ratio which is from 0.05 to 0.95.

Catalytic reactor intended for the implementation of the process for the production of a synthesis gas.

### TECHNICAL FIELD

The present invention belongs to the field of processes for the production of synthesis gas comprising carbon monoxide (CO).

The invention relates more particularly to a process and the associated catalytic reactor with a view to producing a synthesis gas, in which a gas mixture comprising carbon dioxide and hydrogen is brought into contact with a catalyst in order to produce carbon monoxide.

### TECHNICAL BACKGROUND

Carbon dioxide can be converted, under appropriate operating conditions, into carbon monoxide by the following reaction, termed reverse conversion reaction:

CO₂(g)+H₂(g) [symbol] CO(g)+H₂O(g)

This reaction is commonly known by the acronym RWGS for “Reverse Water Gas Shift”, since it is in equilibrium with the reverse “Water Gas Shift” reaction which is intended to form hydrogen mixed with carbon dioxide.

The RWGS reaction is acknowledged to be a very promising route for recovering carbon dioxide and is the subject of numerous studies. The gases that it generates, among others carbon monoxide, make it possible to synthesize various products, such as, for example, methanol.

The RWGS reaction results in an equilibrium between the various constituents. A metal catalyst is generally used to shift this equilibrium toward the formation of carbon monoxide in times compatible with an acceptable reactor size.

Thus, documents EP 0 737 647 (reference [1]) and EP 0 742 172 (reference [2]) describe the use of catalysts based on copper-zinc oxide or based on iron-chromium. These catalysts have the drawback of deactivating after a certain amount of time, among other things under operating conditions which promote the RWGS reaction, such as, for example, temperatures comprised between 400° C. and 600° C. and/or a low partial water pressure, for example less than 20 mol % of water. This deactivating means that the catalyst must be replaced or regenerated, thereby reducing the yield and the economic profitability of the catalytic process for the production of carbon monoxide.

Patent US 2003/113244 (reference [3]) consequently proposes using a catalyst based on zinc oxide and on chromium oxide in order to obtain a good reaction rate for the conversion of carbon dioxide into carbon monoxide. The absence of iron in the catalyst is indicated as essential, this metal element being presented as having the drawback of promoting side reactions of methane and methanol production, or even carbon production.

Nevertheless, such a catalyst based on zinc and on chromium is little efficient for temperatures below 550° C., or it needs to be used in a large amount.

### SUMMARY OF THE INVENTION

One of the aims of the invention is therefore to avoid or reduce one or more of the drawbacks described above, by providing a process for the production of carbon monoxide using a catalyst which exhibits, among other things, a deactivation which is low or even virtually zero over time, for example at the end of a length of time during which it is used of greater than 100 hours.

The present invention thus relates to a process for the production of a synthesis gas, in which a gas mixture comprising carbon dioxide and hydrogen is brought into contact with a catalyst in order to produce carbon monoxide, the process being characterized in that the catalyst comprises iron and silver in a weight of silver/weight of iron ratio which is from 0.05 to 0.95.

The process of the invention is characterized by the use of a catalyst which comprises iron, despite encouragement by the prior art to the contrary, and also silver.

The simultaneous presence of silver and of iron in the catalyst makes it possible to obtain a good reaction rate for the conversion of carbon dioxide into carbon monoxide, while minimizing or even preventing parasitic methane formation or carbon deposition reactions, and also the deactivation of the catalyst.

Too high a proportion of silver in the catalyst can substantially reduce the degree of conversion of the carbon dioxide. On the other hand, too low a proportion does not guarantee good selectivity of the catalyst with respect to the conversion into carbon monoxide, thereby promoting the deposition of carbon on the catalyst and therefore the deactivation thereof. In order to avoid this, the catalyst comprises iron and silver in a weight of silver/weight of iron ratio (namely the weight ratio of silver to iron) which is from 0.05 to 0.95, preferentially from 0.05 to 0.50 in order to further improve the degree of conversion, even more preferentially from 0.10 to 0.30.

The optimum proportion of silver generally tends to increase with the temperature at which the production process of the invention is performed. Thus, at 450° C., the weight of silver/weight of iron ratio can, for example, be between 0.07 and 0.40, and at 500° C. between 0.1 and 0.5.

Preferentially, the catalyst also comprises cerium in a weight of cerium/weight of iron ratio (namely the weight ratio of cerium to iron) which is from 0.1 to 1, preferentially from 0.2 to 0.6. In such an embodiment, the weight ratio of silver to iron remains in the ranges previously indicated.

The addition of cerium further improves the properties of the catalyst comprising iron and silver, such as the reaction rate for the conversion of carbon dioxide into carbon monoxide, by optionally decreasing the catalyst activation time, while preventing the parasitic methane formation or carbon deposition reactions.

The invention also relates to a catalytic reactor capable of being used in the production process as defined in the present description, among others in one or more of the variants described for this process and for the catalyst that it uses, the reactor containing a reaction enclosure in which is placed a catalyst comprising iron and silver in a weight of silver/weight of iron ratio which is from 0.05 to 0.95.

### DETAILED DESCRIPTION OF THE INVENTION

In the present description of the invention, a verb such as “comprise”, “contain”, “incorporate” or “include” and its conjugated forms are open terms and do not therefore exclude the presence of additional element(s) and/or step(s) adding to the initial element(s) and/or step(s) stated after these terms. However, these open terms are also aimed at a particular embodiment in which only the initial element(s) and/or step(s), to the exclusion of any other, are targeted; in which case, the open term is also aimed at the closed term “consist of”, “composed of” and its conjugated forms.

Moreover, unless otherwise indicated, the values at the limits are included in the ranges of parameters indicated.

Generally, the catalyst used in the production process of the invention is such that the iron, the silver and, where appropriate, the cerium are, independently of one another, in native and/or oxide form.

Most commonly, the iron oxidizes because of the catalyst preparation process or because of the presence of water. It forms, for example, an oxide such as magnetite (Fe₃O₄).

The cerium is generally in oxide form, for example in cerium dioxide (CeO₂) form.

Preferentially, the silver is in native form.

The weight ratios of silver to iron or of cerium to iron indicated above are understood to mean the ratios between the weights of iron, of silver or of cerium as metal elements contained in the catalyst, without considering, in the calculation of the weight ratio, the fact that they are optionally in the form of a compound such as an oxide.

Where appropriate, the catalyst may contain other chemical species, constituting, for example, unavoidable manufacturing impurities, as long as these species do not notably affect the catalytic properties. Impurities are, for example, present in the catalyst in a concentration of less than 1%, or even than 0.5%. When the impurity is copper, the concentration may be less than 5%.

The catalyst can be produced by means of any process known to those skilled in the art.

However, it is generally desired to have a catalyst of which the composition is as homogeneous as possible in order to further improve the degree of carbon dioxide conversion. In this respect, the catalyst is preferentially obtained in the usual manner by subjecting a solution comprising an iron nitrate, a silver nitrate and, where appropriate, a cerium nitrate to a precipitation step such as, for example, a coprecipitation or an oxyprecipitation, followed by a calcination step.

A precipitation step is, for example, performed at 70° C. and at a pH of 10 obtained by adding sodium hydroxide or aqueous ammonia, and comprises final steps of washing, filtration, and drying for 24 hours.

The calcination step can be carried out at a temperature between 350° C. and 450° C. for 12 hours and/or in the presence of oxygen, for example under air, a metal oxide then being able to form.

At the end of the calcination step, the catalyst is generally in the form of a more or less agglomerated powder. The average size of the constituent grains of the powder is generally between 20 μm and 500 μm, or even between 20 μm and 100 μm after optional screening, in which case the grains of the powder have, for example, a BET specific surface area of 50 m²/g to 200 m²/g.

The catalyst can be used as it is in the production process of the invention, or else can be impregnated onto a support or mixed with a support.

A support normally used in the catalysis field is suitable for such an embodiment.

Such a support is generally inert with respect to the physicochemical conditions, to the reagents and to the products of the RWGS reaction. It is, for example, composed of alumina, of zeolite or of silica. It can be shaped, for example as granules or balls.

For bringing it into contact with the gas mixture, the catalyst can constitute a catalytic bed placed, for example, in a fixed-bed or fluidized-bed catalytic reactor, the gas mixture passing through the catalytic bed. The catalyst is, for example, in the form of catalytic particles with a BET specific surface area of at least 50 m²/g, for example from 50 m²/g to 200 m²/g. It can also be mixed with, or impregnated onto, particles of the inert support previously described.

In the fixed-bed reactor, the catalyst is placed in a container, generally a vertical cylindrical container. The stream of gas mixture and of the synthesis gas obtained runs through the bed thus formed, in order to keep the particles in suspension.

In the fluidized-bed reactor, the catalyst is generally in the form of a powder, kept in suspension by the ascending passing of the gas mixture.

Where appropriate, the catalyst can be pretreated by subjecting it to hydrogen mixed with helium, water vapor, carbon monoxide or mixtures thereof. This pretreatment gives the best possible activation of the iron catalytic phases. It is performed, for example, for 1 hour to 5 hours at a temperature comprised between 200° C. and 350° C.

The amount of catalyst or the length of time during which it is used can vary to a large extent which can, for example, depend on the temperature, on the reaction volume, on whether or not a continuous system is used, on the flow rate of the gas mixture, on the specific surface area of the catalyst. Those skilled in the art will be able to easily adjust the amount of catalyst or the time during which it is used according to the conditions that they encounter, until the catalytic activity or the degree of conversion that they desired is obtained.

By way of example, the hourly volume velocity of the gas mixture entering the catalytic bed is between 10 000 Nm³/hour and 30 000 Nm³/hour per m³ of catalyst. By convention, 1 Nm³ represents the volume of a cubic meter under normal temperature and pressure conditions, namely 25° C. and 1 bar. The hourly volume velocity generally increases with the amount of catalyst.

Because it is barely or not at all subject to deactivation, the catalyst can be used continuously or discontinuously, for a length of time for example greater than 100 hours, or even than 200 hours, for example between 100 hours and 3000 hours, while preserving a stable or relatively stable degree of carbon dioxide conversion.

The production process of the invention is generally performed under a pressure of 1 bar to 50 bar, and/or all or part of this process at a temperature comprised between 400° C. and 550° C., preferentially between 420° C. and 520° C., in the knowledge that the degree of conversion generally increases with the temperature.

The gas mixture treated according to the production process of the invention comprises carbon dioxide and hydrogen, generally representing at least 50% by volume of the gas mixture, particularly at least 70%, even more particularly at least 90%.

The mole ratio, within the gas mixture, of hydrogen to carbon dioxide can vary to a large extent between 0.1 and 100. It is, for example, comprised between 0.8 and 10, and more particularly between 2 and 4.

The presence of at least one other additional chemical species in the gas mixture is not excluded. Thus, for example, the initial gas mixture may also comprise at least one chemical species such as water vapor, methane, carbon monoxide or a chemically inert gas (such as, for example, argon or helium).

Advantageously, the gas mixture can come from the water-vapor reforming or oxygen reforming of hydrocarbons. It then contains essentially carbon monoxide, carbon dioxide and hydrogen.

The carbon dioxide can also constitute the residual gas of an ammonia production unit.

The synthesis gas obtained at the end of the production process of the invention contains carbon monoxide and water generally in vapor form, and also unreacted carbon dioxide and unreacted hydrogen, or even possibly a small amount of carbon-based products resulting from parasitic reactions. These carbon-based products are for example methane, the concentration by volume of which is generally less than 1%, more particularly than 0.5%, even more particularly than 0.1%.

According to a preferred embodiment, the production process of the invention comprises an additional step during which at least one cycle consisting in i) extracting all or part of the water contained in the synthesis gas, then in ii) repeating the production process, is carried out. By shifting the reaction equilibrium, this extraction favors the RWGS reaction and therefore the enrichment of the synthesis gas in carbon monoxide by conversion of an additional fraction of carbon dioxide.

The extraction of all or part of the water can be performed by a conventional means, such as a desiccation or preferably a condensation.

The condensation is, for example, performed by bringing the synthesis gas to a temperature between 0° C. and 70° C., preferably between 35° C. and 55° C. The condensation temperature may, however, vary according to the pressure of the synthesis gas.

In an ultimate step of the production process of the invention, the synthesis gas can be used to synthesize a hydrocarbon carbon which is, for example, methanol, dimethyl ether or a paraffin.

Other subjects, characteristics and advantages of the invention will now be specified in the description which follows of specific embodiments of the process of the invention and of comparative examples.

### DESCRIPTION OF SPECIFIC EMBODIMENTS

The conversion of a gas mixture at a pressure of 1 bar containing by volume 75% of hydrogen and 25% of carbon dioxide is performed by passing it through, according to a continuous flow rate of 100 ml/hour, a fixed catalytic bed containing a catalyst based on iron and on silver, and where appropriate on cerium, in accordance with the production process of the invention.

By way of comparison, conversions performed under the same conditions are also carried out with catalysts of different composition.

The composition of the synthesis gas obtained is measured by gas chromatography at the outlet of the catalytic bed. This measurement makes it possible to calculate the amount of carbon dioxide converted: it corresponds to the mole fraction of carbon dioxide converted into carbon monoxide.

### 1. MANUFACTURING OF A CATALYST AND USE IN A CATALYTIC BED

An aqueous solution comprising an iron metal nitrate (Fe(NO₃)₃) and a silver metal nitrate (AgNO₃), and where appropriate a cerium nitrate (Ce(NO₃)₃), is prepared. The nitrates present in the solution are coprecipitated at 70° C. after the addition of sodium hydroxide in order to obtain a pH of 10. After the precipitation step, each Fe, Ag and Ce metal element is then present at the concentration in which it will be found in the catalyst. The precipitates obtained are washed, filtered, dried at 70° C. for 24 hours, and calcined under air at 350° C. for 4 hours and then at 450° C. for 8 hours.

A powder is obtained, the average size of the grains of which is comprised between 20 μm and 500 μm, and which constitutes the catalyst that can be used in the production process of the invention. After screening, only the grains with an average size of less than 100 μm are saved, such a particle size generally making it possible to obtain a better efficiency of the catalyst.

A glass tube is then filled with a variable amount of the catalyst in order to obtain a fixed-bed catalytic reactor which is placed vertically in a furnace at a controlled temperature.

Before performing the conversion of the gas mixture, the catalyst is conditioned by flushing it for 2 hours with a stream of hydrogen mixed with helium.

By way of comparison, according to a procedure similar to the one described for the catalyst based on iron, on silver and, where appropriate, on cerium, catalysts based on iron and on chrome and optionally on copper, or on iron and on cerium, are manufactured by coprecipitation of the corresponding nitrates (or of the corresponding chloride in the case of chromium), integrated in the form of a catalytic bed and conditioned by flushing with hydrogen.

The composition of the catalysts obtained is expressed as percentage by weight. Their specific surface area is similar.

### 2. CATALYTIC CONVERSION OF A GAS MIXTURE AT A TEMPERATURE OF 450° C.

Each catalyst is used separately in the form of a fixed catalytic bed in order to perform catalytic conversions of the gas mixture at a temperature of 450° C. (+/−2° C.)

2.1. Catalytic Conversion According to the Invention

Catalysts comprising iron, silver and, where appropriate, cerium make it possible to obtain the following conversion kinetics:

TABLE A
Fe = 5%, Ag = 95%
(amount = 150 mg)

| Conversion | Amount of CO₂ |
|---|---|
| time (hours) | converted |
| 10 | 0.09 |
| 100 | 0.09 |

TABLE B
Fe = 70%, Ce = 22%, Ag = 8%
(amount = 10 mg)

| Conversion time | Amount of CO₂ |
|---|---|
| (hours) | converted |
| 20 | 0.23 |
| 50 | 0.23 |
| 100 | 0.226 |

TABLE C
Fe = 80%, Ce = 12%, Ag = 8%
(amount = 10 mg)

| Conversion | Amount of CO₂ |
|---|---|
| time (hours) | converted |
| 20 | 0.15 |
| 50 | 0.15 |
| 100 | 0.15 |
| 300 | 0.15 |

During these conversions, no signal characteristic of methane, which is detectable in practice by gas chromatography starting from a concentration of 0.1%, is detected.

2.2. Catalytic Conversion by Way of Comparison

By way of comparison, various catalysts are used in the catalytic conversion process and make it possible to obtain the following conversion kinetics:

TABLE D
Fe = 87%, Cr = 9%, Cu = 4%
(amount = 10 mg)

| Conversion | Amount of CO₂ |
|---|---|
| time (hours) | converted |
| 20 | 0.15 |
| 50 | 0.11 |
| 100 | 0.047 |

TABLE E
Fe = 92%, Ce = 8%
(amount = 10 mg)

| Conversion | Amount of CO₂ |
|---|---|
| time (hours) | converted |
| 20 | 0.23 |
| 50 | 0.17 |
| 100 | 0.10 |

TABLE F
Fe = 92%, Cr = 8%
(amount = 10 mg)

| Conversion | Amount of CO₂ |
|---|---|
| time (hours) | converted |
| 20 | 0.11 |
| 50 | 0.07 |
| 100 | 0.04 |

### 3. CONVERSION OF A GAS MIXTURE AT A TEMPERATURE OF 500° C.

Each catalyst is used separately in the form of a fixed catalytic bed in order to perform catalytic conversions of the gas mixture at a temperature of 500° C. (+/−2° C.).

3.1. Catalytic Conversion According to the Invention

Catalysts comprising iron, silver and, where appropriate, cerium make it possible to obtain the following conversion kinetics:

TABLE G
Fe = 85%, Ag = 15%
(amount = 40 mg)

| Conversion | Amount of CO₂ |
|---|---|
| time (hours) | converted |
| 1 | 0.25 |
| 20 | 0.26 |
| 100 | 0.26 |

TABLE H
Fe = 85%, Ag = 15%
(amount = 1 g)

| Conversion | Amount of CO₂ |
|---|---|
| time (hours) | converted |
| 1 | 0.47 |
| 20 | 0.49 |
| 100 | 0.49 |

TABLE I
Fe = 43%, Ce = 42%, Ag = 15%
(amount = 10 mg)

| Conversion | Amount of CO₂ |
|---|---|
| time (hours) | converted |
| 10 | 0.16 |
| 20 | 0.17 |
| 50 | 0.18 |
| 100 | 0.18 |

TABLE J
Fe = 70%, Ce = 22%, Ag = 8%
(amount = 10 mg)

| Conversion | Amount of CO₂ |
|---|---|
| time (hours) | converted |
| 10 | 0.21 |
| 20 | 0.22 |
| 50 | 0.22 |
| 100 | 0.175 |

The degree of conversion after 100 hours of Table J shows that the amount of silver in the catalyst is insufficient to stabilize an efficient conversion for such a long length of time. Such a phenomenon is noted neither in Table I in which the catalyst contains double the amount of silver, nor in Table B for which the temperature is 450° C. This shows that the proportion of silver in the catalyst must generally increase with the working temperature if it is desired to maintain a stable degree of conversion.

The comparison of Tables J and G shows that cerium increases the efficiency of the catalyst, since the amount of catalyst is then respectively 10 mg instead of 40 mg, with a similar degree of conversion being obtained.

TABLE K
Fe = 70%, Ce = 22%, Ag = 8%
(amount = 200 mg)

| Conversion | Amount of CO₂ |
|---|---|
| time (hours) | converted |
| 10 | 0.48 |
| 20 | 0.49 |
| 50 | 0.49 |

The use of a larger amount of the Fe/Ag or Fe/Ag/Ce catalyst makes it possible to improve the degree of conversion and to move it closer to that of the thermodynamic equilibrium equal to 0.5.

During the conversions, no signal characteristic of methane is detected.

3.2. Catalytic Conversion by Way of Comparison

TABLE L
Fe = 87%, Cr = 9%, Cu = 4%
(amount = 10 mg)

| Conversion | Amount of CO₂ |
|---|---|
| time (hours) | converted |
| 10 | 0.17 |
| 20 | 0.14 |
| 50 | 0.10 |

TABLE M
Fe = 92%, Cr = 8%
(amount = 10 mg)

| Conversion | Amount of CO₂ |
|---|---|
| time (hours) | converted |
| 10 | 0.12 |
| 20 | 0.105 |
| 50 | 0.065 |

### 4. CONCLUSION

The preceding measurements show that, compared with a Fe/Cr, Fe/Cr/Cu or Fe/Cr catalyst, the Fe/Ag or Fe/Ag/Ce catalyst makes it possible to obtain an amount of carbon dioxide converted which is higher or similar, and which is stable after a prolonged use.

### REFERENCES CITED

[1] EP 0 737 647
[2] EP 0 742 172
[3] US 2003/113244

1. The process for the production of a synthesis gas, in which a gas mixture comprising carbon dioxide and hydrogen is brought into contact with a catalyst in order to produce carbon monoxide, said process being characterized in that the catalyst comprises iron and silver in a weight of silver/weight of iron ratio which is from 0.05 to 0.95.

2. The process for the production of a synthesis gas according to claim 1, wherein the catalyst also comprises cerium in a weight of cerium/weight of iron ratio which is from 0.1 to 1.

3. The process for the production of a synthesis gas according to claim 1, wherein the iron, the silver and, where appropriate, the cerium are, independently of one another, in native and/or oxide form.

4. The process for the production of a synthesis gas according to claim 1, wherein the catalyst is obtained by subjecting a solution comprising an iron nitrate, a silver nitrate and, where appropriate, a cerium nitrate to a coprecipitation or oxyprecipitation step, followed by a calcination step.

5. The process for the production of a synthesis gas according to claim 1, wherein the catalyst is impregnated onto a support or mixed with a support.

6. The process for the production of a synthesis gas according to claim 5, wherein the support is composed of alumina, of zeolite or of silica.

7. The process for the production of a synthesis gas according to claim 1, wherein the catalyst constitutes a catalytic bed placed in a fixed-bed or fluidized-bed catalytic reactor.

8. The process for the production of a synthesis gas according to claim 1, wherein the catalyst is pretreated by subjecting it to hydrogen mixed with helium, water vapor, carbon monoxide or mixtures thereof.

9. The process for the production of a synthesis gas according to claim 1, wherein all or part of said process is performed at a temperature comprised between 400° C. and 550° C.

10. The process for the production of a synthesis gas according to claim 1, wherein the gas mixture comprises at least 50% by volume of carbon dioxide and of hydrogen.

11. The process for the production of a synthesis gas according to claim 1, wherein the gas mixture is such that the hydrogen/carbon dioxide mole ratio is comprised between 0.8 and 10.

12. The process for the production of a synthesis gas according to claim 1, wherein the gas mixture comprises at least one chemical species such as water vapor, methane, carbon monoxide or a chemically inert gas.

13. The process for the production of a synthesis gas according to claim 1, wherein the gas mixture comes from the water-vapor reforming or oxygen reforming of hydrocarbons.

14. The process for the production of a synthesis gas according to claim 1, wherein at least one cycle consisting in i) extracting all or part of the water contained in the synthesis gas, then in ii) repeating said production process, is carried out.

15. The process for the production of a synthesis gas according to claim 1, wherein the synthesis gas is used to synthesize a hydrocarbon.

16. The process for the production of a synthesis gas according to claim 15, wherein the hydrocarbon is methanol, dimethyl ether or a paraffin.

17. (canceled)
